(19) United States
(12) Patent Application Publication
(10) Pub. No.: US 2010/0224035 A1
(43) Pub. Date: Sep. 9, 2010

(54) Driving Tool Kit Including Driving Tools and Method for Determining Driving Angles of Driving Tools

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/647,592

(22) Filed: Dec. 28, 2009

(30) Foreign Application Priority Data
Mar. 3, 2009 (TW) 098106903

(51) Int. Cl. B25B 13/06

(52) U.S. Cl. 81/121.1

(57) ABSTRACT

A driving tool kit includes at least three driving tools each having an opening for selectively receiving one of first and second fasteners with nominal sizes of different units. The opening includes an inner periphery having a plurality of driving sections. Each driving section includes first and second planar driving faces meeting at an intersection and at an obtuse driving angle to each other. The intersections of the driving sections are capable of engaging with sides of a larger one of the first and second fasteners. The first planar driving faces and the second planar driving faces of the driving sections are capable of selectively engaging with sides of a smaller one of the first and second fasteners. The driving angles of the driving tools are different from one another and can be determined by a method.

### BACKGROUND OF THE INVENTION

1. Field of the Invention

The present invention relates to a method for determining a driving angle of an opening of a driving tool such as a wrench, a socket, or the like, and, more particularly, to a method for determining a driving angle of a driving tool capable of driving a first fastener of a nominal size of imperial units for fasteners and a second fastener of a nominal size of metric units for fasteners corresponding to the nominal size of imperial units for fasteners. The present invention also relates to a driving tool kit including at least three driving tools having differing driving angles obtained from the method.

2. The Prior Arts

The sizes of fasteners, such as bolts, nuts, etc., are generally of either metric units or imperial units. To save costs, driving tools such as wrenches, sockets, or the like capable of driving fasteners of different units have been proposed. However, the conventional driving tool fittingly driving a fastener of a nominal size of one of the metric and imperial units is often in loose contact or has a smaller engaging area with another fastener of a corresponding nominal size of the other of the metric and imperial units due to the nominal size difference of the fasteners between the metric and imperial units, leading to the risk of damage to the fasteners. Solutions to this problem may lead to a change in the shapes or the number of the driving faces of the driving tools and require additional molds for the driving tools. Thus, the manufacturing costs are increased. Furthermore, the more the driving faces of the driving tools, the more difficult to engage the driving tools with the fasteners. Further, conventional methods for determining the driving angles of the driving tools are complicated.

Thus, a need exists for a novel driving tool kit including driving tools capable of driving fasteners of different units without the risk of damage to the fasteners and for a method for determining driving angles of the driving tools of the driving tool kit.

### SUMMARY OF THE INVENTION

The present invention solves this need and other problems in the field of driving surfaces of a driving tool by providing, in a preferred aspect, a novel method for determining a driving angle of an opening of a driving tool. The opening is adapted to selectively receive one of a first fastener with a nominal size of imperial units for fasteners and a second fastener with a nominal size of metric units for fasteners corresponding to the nominal size of imperial units for fasteners. Each of the first and second fasteners includes six sides. The opening includes an inner periphery having six driving sections spaced from one another at regular intervals in a circumferential direction. Each of the driving sections includes first and second planar driving faces at a driving angle to each other. Firstly, the method includes drawing a first hexagon having six first sides corresponding to the six sides of a larger one of the first and second fasteners. The first hexagon defines a center surrounded by the six first sides. A midpoint of one of the six first sides of the first hexagon is selected as a reference point. Next, a second hexagon is drawn inside of and concentric with the first hexagon. The second hexagon includes six second sides corresponding to the six sides of a smaller one of the first and second fasteners. The six second sides of the second hexagon are respectively parallel to and spaced from the six first sides of the first hexagon. One of the six second sides of the second hexagon is selected as a reference side. Then, the second hexagon is rotated about the center in a clockwise direction to a first position with the reference side of the second hexagon intersecting the reference point of the first hexagon. The reference side of the second hexagon in the first position has a first segment extending from the reference point and outside of the first hexagon. Furthermore, the second hexagon is rotated about the center in a counterclockwise direction to a second position with the reference side of the second hexagon intersecting the reference point of the first hexagon. The reference side of the second hexagon in the second position has a second segment extending from the reference point and outside of the first hexagon. The first and second segments outside of the first hexagon meet at the reference point and define an obtuse angle. The obtuse angle is used as the driving angle of each of the six driving sections of the driving tool.

In accordance with another preferred aspect of the present invention, a driving tool kit includes a first driving tool having a first opening adapted to selectively receive one of a first fastener with a first nominal size of imperial units for fasteners and a second fastener with a first nominal size of metric units for fasteners corresponding to the first nominal size of imperial units for fasteners. Each of the first and second fasteners includes a plurality of sides. The first opening includes a first central axis and a first inner periphery surrounding the first central axis. The first inner periphery includes a plurality of first driving sections spaced from one another at regular intervals in a first circumferential direction surrounding the first central axis. Each of the plurality of first driving sections includes first and second planar driving faces meeting at a first intersection and at a first obtuse driving angle to each other. The first intersections of the plurality of first driving sections are adapted to engage with the plurality of sides of a larger one of the first and second fasteners. The first planar driving faces and the second planar driving faces of the plurality of first driving sections are adapted to selectively engage with the plurality of sides of a smaller one of the first and second fasteners.

The driving tool kit further includes a second driving tool having a second opening adapted to selectively receive one of a third fastener with a second nominal size of imperial units for fasteners and a fourth fastener with a second nominal size of metric units for fasteners corresponding to the second nominal size of imperial units for fasteners. The second nominal size of imperial units for fasteners is different from the first nominal size of imperial units for fasteners. The second nominal size of metric units for fasteners is different from the first nominal size of metric units for fasteners. Each of the third and fourth fasteners includes a plurality of sides. The second opening includes a second central axis and a second inner periphery surrounding the second central axis. The second inner periphery includes a plurality of second driving sections spaced from one another at regular intervals in a second circumferential direction surrounding the second central axis. Each of the plurality of second driving sections includes third and fourth planar driving faces meeting at a second intersection and at a second obtuse driving angle to each other. The second obtuse driving angle is different from the first obtuse driving angle. The second intersections of the plurality of second driving sections are adapted to engage with the plurality of sides of a larger one of the third and fourth fasteners. The third planar driving faces and the fourth planar driving faces of the plurality of second driving sections are adapted to selectively engage with the plurality of sides of a smaller one of the third and fourth fasteners.

The driving tool kit further includes a third driving tool having a third opening adapted to selectively receive one of a fifth fastener with a third nominal size of imperial units for fasteners and a sixth fastener with a third nominal size of metric units for fasteners corresponding to the third nominal size of imperial units for fasteners. The third nominal size of imperial units for fasteners is different from the first and second nominal sizes of imperial units for fasteners. The third nominal size of metric units for fasteners is different from the first and second nominal sizes of metric units for fasteners. Each of the fifth and sixth fasteners includes a plurality of sides. The third opening includes a third central axis and a third inner periphery surrounding the third central axis. The third inner periphery includes a plurality of third driving sections spaced from one another at regular intervals in a third circumferential direction surrounding the third central axis. Each of the plurality of third driving sections includes fifth and sixth planar driving faces meeting at a third intersection and at a third obtuse driving angle to each other. The third obtuse driving angle is different from the first and second obtuse driving angles. The third intersections of the plurality of third driving sections are adapted to engage with the plurality of sides of a larger one of the fifth and sixth fasteners. The fifth planar driving faces and the sixth planar driving faces of the plurality of third driving sections are adapted to selectively engage with the plurality of sides of a smaller one of the fifth and sixth fasteners.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1A shows a view of two concentric hexagons, with six sides of one of the hexagons corresponding to six sides of a first fastener with a first nominal size of one of imperial and metric units for fasteners, with six sides of the other hexagon corresponding to six sides of a second fastener with a second nominal size of the other of imperial and metric units for fasteners corresponding to the first nominal size.

FIG. 1B shows a view of two concentric hexagons larger than the hexagons of FIG. 1A, with six sides of one of the hexagons of FIG. 1B corresponding to six sides of a third fastener with a third nominal size of one of imperial and metric units for fasteners, with six sides of the other hexagon of FIG. 1B corresponding to six sides of a fourth fastener with a fourth nominal size of the other of imperial and metric units for fasteners corresponding to the third nominal size.

FIG. 1C shows a view of two concentric hexagons larger than the hexagons of FIG. 1B, with six sides of one of the hexagons of FIG. 1C corresponding to six sides of a fifth fastener with a fifth nominal size of one of imperial and metric units for fasteners, with six sides of the other hexagon of FIG. 1C corresponding to six sides of a sixth fastener with a sixth nominal size of the other of imperial and metric units for fasteners corresponding to the fifth nominal size.

FIG. 2A shows a view similar to FIG. 1A, with the smaller hexagon of FIG. 1A rotated about a center in the clockwise and counterclockwise directions to two positions to intersect the larger hexagon at a common reference point.

FIG. 2B shows a view similar to FIG. 1B, with the smaller hexagon of FIG. 1B rotated about a center in the clockwise and counterclockwise directions to two positions to intersect the larger hexagon at a common reference point.

FIG. 2C shows a view similar to FIG. 1C, with the smaller hexagon of FIG. 1C rotated about a center in the clockwise and counterclockwise directions to two positions to intersect the larger hexagon at a common reference point.

FIG. 3A shows a view similar to FIG. 2A with the hexagons of FIG. 2A surrounded by a circle having a diameter the same as an inner periphery of an opening of a driving tool.

FIG. 3B shows a view similar to FIG. 2B with the hexagons of FIG. 2B surrounded by a circle having a diameter the same as an inner periphery of an opening of a driving tool.

FIG. 3C shows a view similar to FIG. 2C with the hexagons of FIG. 2C surrounded by a circle having a diameter the same as an inner periphery of an opening of a driving tool.

FIG. 4A shows a schematic view illustrating formation of a plurality of driving sections and a concave portion intermediate two adjacent driving sections in FIG. 3A with a portion of the circle shown in dotted lines.

FIG. 4B shows a schematic view illustrating formation of a plurality of driving sections and a concave portion intermediate two adjacent driving sections in FIG. 3B with a portion of the circle shown in dotted lines.

FIG. 4C shows a schematic view illustrating formation of a plurality of driving sections and a concave portion intermediate two adjacent driving sections in FIG. 3C with a portion of the circle shown in dotted lines.

FIG. 5A shows a view similar to FIG. 4A with the hexagons of FIG. 4A surrounded by another circle defining an outer periphery of a driving tool.

FIG. 5B shows a view similar to FIG. 4B with the hexagons of FIG. 4B surrounded by another circle defining an outer periphery of a driving tool.

FIG. 5C shows a view similar to FIG. 4C with the hexagons of FIG. 4C surrounded by another circle defining an outer periphery of a driving tool.

FIGS. 6A, 6B, and 6C show schematic views of driving tools according to the teachings of the present invention with the driving tools having different driving angles.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “fourth” “fifth”, “sixth”, “inside”, “side”, “periphery”, “section”, “bottom”, “spacing”, “radial”, “inner”, “outer”, “circumferential”, “length”, and similar terms are used herein, it should be understood that these terms have reference only to the structure shown in the drawings as it would appear to a person viewing the drawings and are utilized only to facilitate describing the invention.

### DETAILED DESCRIPTION OF THE PREFERRED EMBODIMENT

A fastener such as a bolt, a nut, or the like generally includes a plurality of sides and has a nominal size in metric or imperial units. Table 1 shows some examples of differences between the nominal sizes of metric units for fasteners and corresponding nominal sizes of imperial units for fasteners.

TABLE 1

| mm | 8 | 9 | 10 | 11 | 12 | 13 | 14 | 16 | 17 | 19 |
|---|---|---|---|---|---|---|---|---|---|---|
| inch | 5/16 | 11/32 | ⅜ | 7/16 | 15/32 | ½ | 9/16 | ⅝ | 11/16 | ¾ |
| (mm) | 7.93 | 8.73 | 9.5 | 11.11 | 11.9 | 12.9 | 14.28 | 15.87 | 17.46 | 19.05 |
| difference | 0.07 | 0.27 | 0.5 | 0.11 | 0.1 | 0.1 | 0.28 | 0.13 | 0.46 | 0.05 |

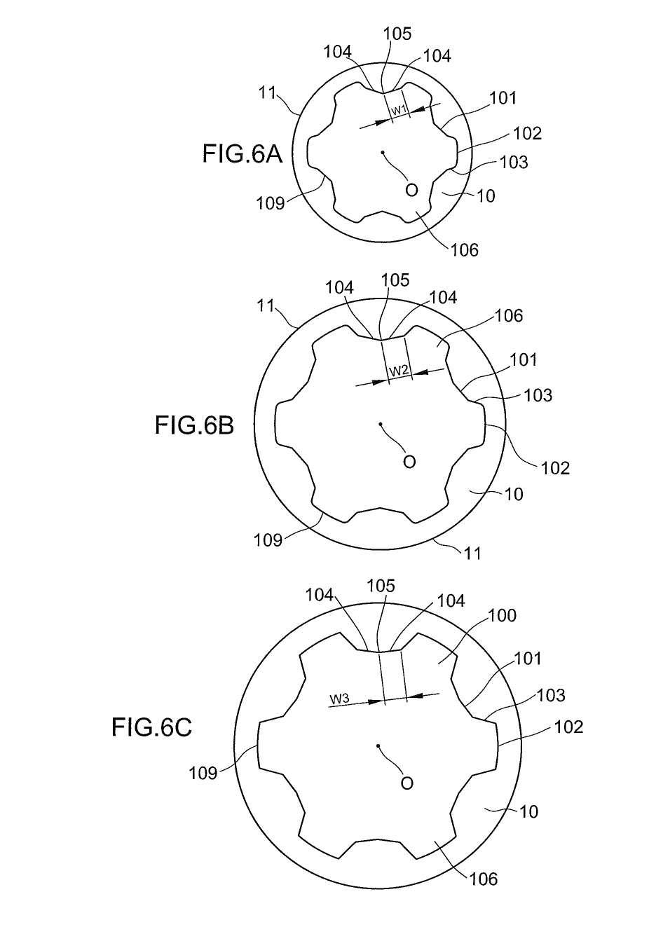

A method according to the preferred teachings is provided to determine driving angles of driving tools of a driving tool kit to avoid the disadvantages resulting from the differences in the nominal sizes of fasteners of different units encountered in the prior art. To assist in easy understanding of the present invention, the driving tool kit according to the teachings of the present invention will be firstly described with reference to examples shown in FIGS. 6A-6C. Specifically, the driving tool kit according to the teachings of the present invention includes first, second, third driving tools, such as wrenches, sockets, or the like, respectively shown in the FIGS. 6A-6C and designated 10. Each driving tool 10 includes an opening 100 for driving a fastener. The sizes of openings 100 of first, second, and third driving tools 10 are different from one another. Opening 100 of each of first, second, and third driving tools 10 can receive either a first fastener with a nominal size of imperial units for fasteners or a second fastener with a nominal size of metric units for fasteners corresponding to the nominal size of imperial units for fasteners. Each opening 100 includes a central axis O and an inner periphery 109 surrounding central axis O and spaced from an outer periphery 11 of driving tool 10 in a radial direction. Each inner periphery 109 includes a plurality of driving sections 101 spaced from one another at regular intervals in a circumferential direction surrounding central axis O. Each driving section 101 includes first and second planar driving faces 104 meeting at an intersection 105 and at an obtuse driving angle θ1, θ2, θ3 to each other. Each of first and second planar driving faces 104 has a length W1, W2, W3. Each inner periphery 109 further includes a plurality of concave portions 106. Each concave portion 106 is formed between two adjacent driving sections 101 and includes two side faces 103 and a bottom side 102 interconnected between side faces 103. Each side face 103 of each concave portion 106 is interconnected to one of first and second planar driving faces 104. Each bottom side 102 has a spacing to central axis O in a radial direction perpendicular to the circumferential direction larger than each of first and second planar driving faces 104. Intersections 105 of driving sections 101 of each driving tool 10 are adapted to engage with the sides of a larger one of the first and second fasteners. First planar driving faces 104 and second planar driving faces 104 of the driving sections 101 of each driving tool 10 are adapted to selectively engage with the sides of a smaller one of the first and second fasteners, depending on the moving direction of driving tool 10 relative to the smaller one of the first and second fasteners. Driving angles θ1, θ2, θ3 of driving sections 101 of first, second, and third driving tools 10 are different from one another. It can be appreciated that the driving tool kit according to the teachings of the present invention can include more than three driving tools 10.

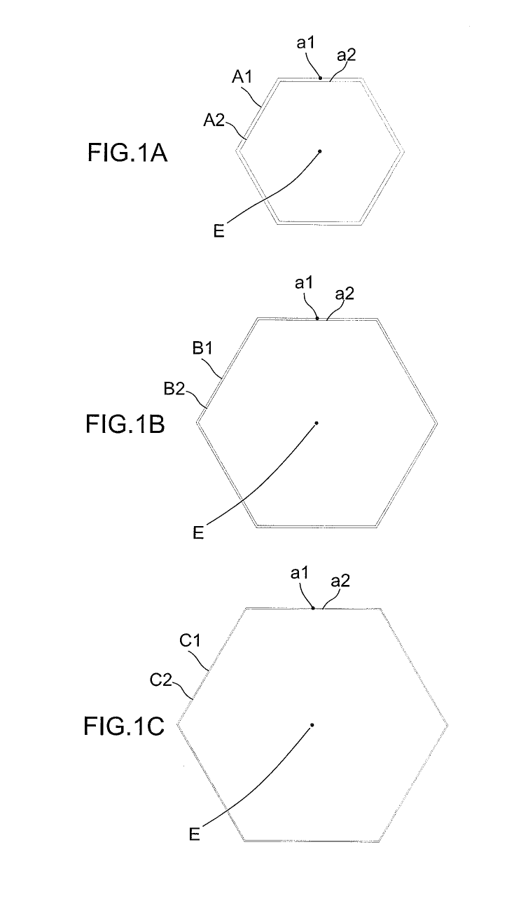

The method for determining driving angles θ1, θ2, θ3 of driving tools 10 according to the preferred teachings of the present invention will now be set forth. FIG. 1A illustrates a larger hexagon A1 corresponding to a 10 mm fastener and a smaller hexagon A2 corresponding to a ⅜ inch fastener with the difference between the nominal sizes of the two fasteners being 0.5 mm. Similarly, FIG. 1B illustrates a larger hexagon B1 corresponding to a 9/16 inch fastener and a smaller hexagon B2 corresponding to a 14 mm fastener with the difference between the nominal sizes of the two fasteners being 0.28 mm. Similarly, FIG. 1C illustrates a larger hexagon C1 corresponding to a 16 mm fastener and a smaller hexagon C2 corresponding to a ⅝ inch fastener with the difference between the nominal sizes of the two fasteners being 0.13 mm.

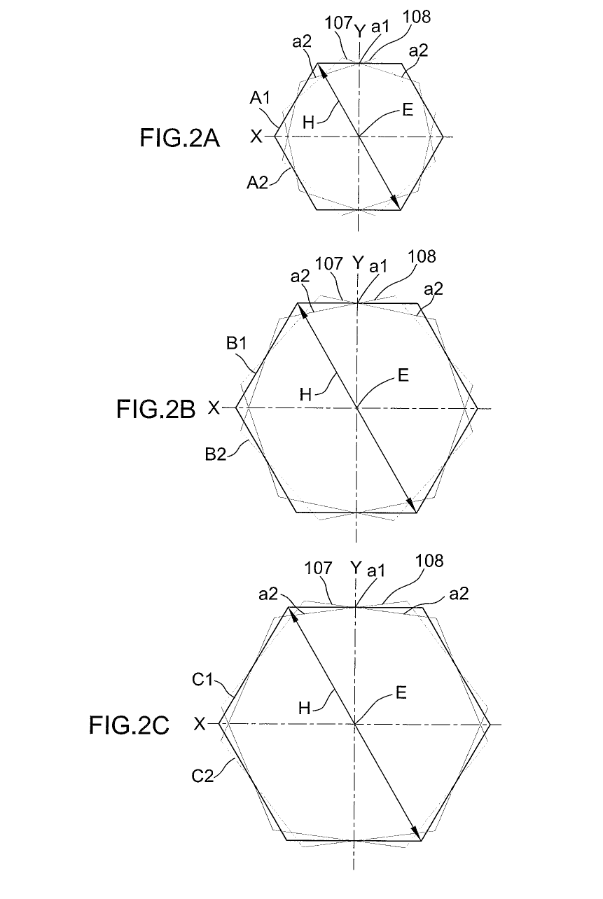

Specifically, the method for determining a driving angle of a driving tool according to the preferred teachings of the present invention includes drawing a first hexagon A1, B1, C1 having six first sides corresponding to the six sides of the larger one of the first and second fasteners. First hexagon A1, B1, C1 defines a center E surrounded by the six first sides. A midpoint of one of the six first sides of first hexagon A1, B1, C1 is selected as a reference point a1. Next, a second hexagon A2, B2, C2 is drawn inside of and concentric with first hexagon A1, B1, C1. Second hexagon A2, B2, C2 includes six second sides corresponding to the six sides of a smaller one of the first and second fasteners. The six second sides of second hexagon A2, B2, C2 are respectively parallel to and spaced from the six first sides of first hexagon A1, B1, C1. One of the six second sides of second hexagon A2, B2, C2 is selected as a reference side a2. Referring to FIGS. 2A-2C, second hexagon A2, B2, C2 is rotated about center E in a clockwise direction to a first position with reference side a2 of second hexagon A2, B2, C2 intersecting reference point a1 of first hexagon A1, B1, C1. Reference side a2 of second hexagon A2, B2, C2 in the first position has a first segment 107 extending from reference point a1 and outside of first hexagon A1, B1, C1. Then, second hexagon A2, B2, C2 is rotated about center E in a counterclockwise direction to a second position with reference side a2 of second hexagon A2, B2, C2 intersecting reference point a1 of first hexagon A1, B1, C1. Reference side a2 of second hexagon A2, B2, C2 in the second position has a second segment 108 extending from reference point a1 and outside of first hexagon A1, B1, C1. First and second segments 107 and 108 outside of first hexagon A1, B1, C1 meet at reference point a1.

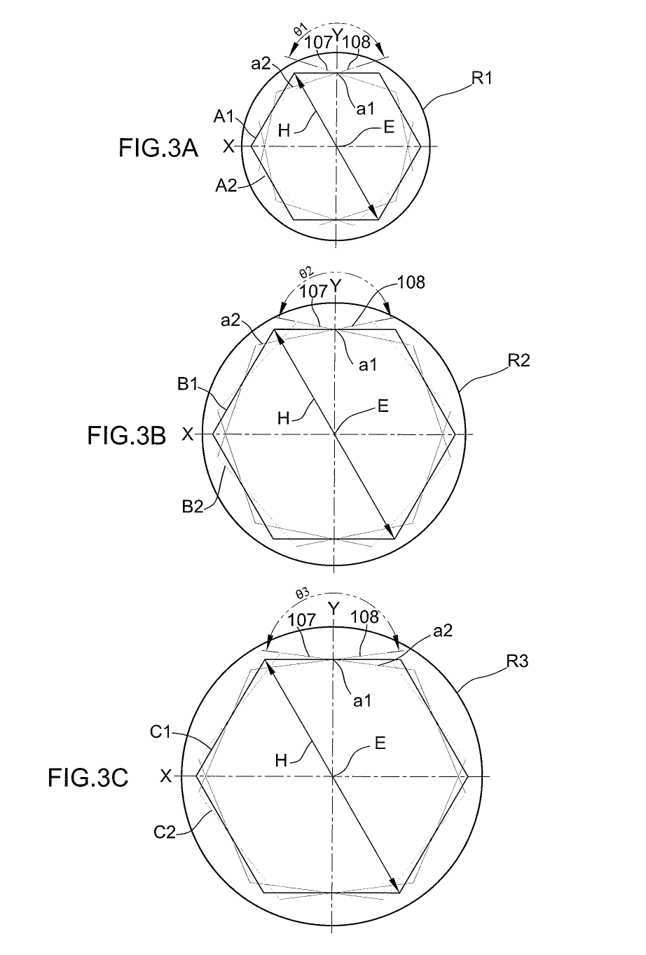

Referring to FIGS. 3A-3C, a circle R1, R2, R3 concentric with first hexagon A1, B1, C1 is drawn and surrounds the first and second hexagons A1, B1, C1 and A2, B2, C2. Circle R1, R2, R3 has a diameter greater than a maximum diameter H of the larger one of the first and second fasteners. Further, first and second segments 107 and 108 outside of first hexagon A1, B1, C1 define an obtuse angle θ1, θ2, θ3.

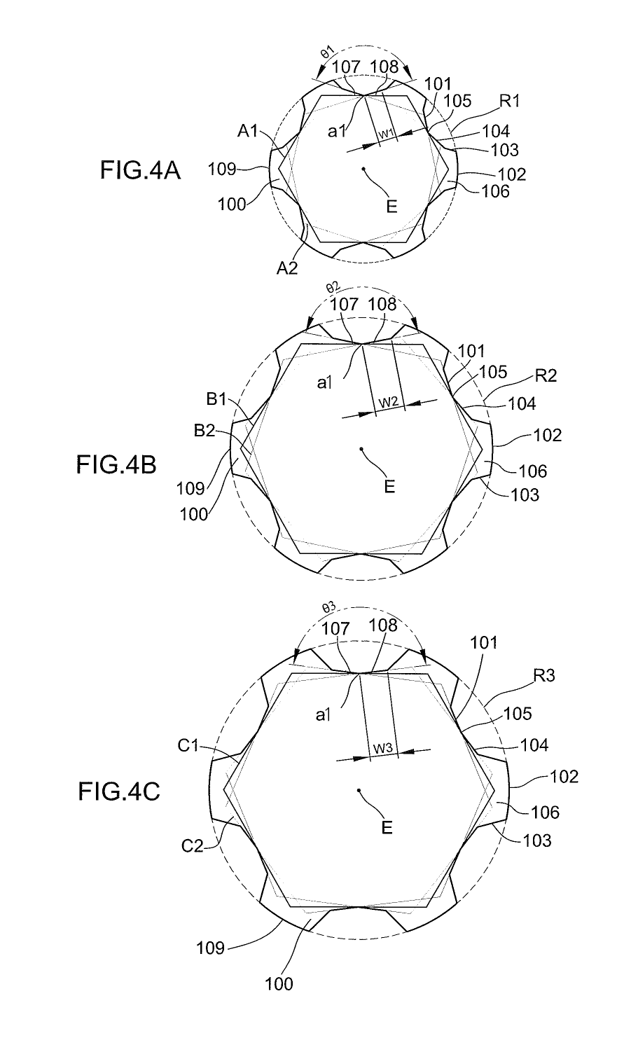

Referring to FIGS. 4A-4C, circle R1, R2, R3 defines the majority of and has the same diameter as inner periphery 109 of opening 100 of driving tool 10 of FIGS. 6A, 6B, 6C. Six spaced driving sections 101 and six spaced concave portion 106 of driving tool 10 are formed in circle R1, R2, R3. Each driving section 101 includes first and second planar driving faces 104 meeting at the obtuse driving angle θ1, θ2, θ3 to each other. Specifically, length W1, W2, W3 of each first planar driving face 104 is selected from a portion of first segment 107, and length W1, W2, W3 of each second planar driving face 104 is selected from a portion of second segment 108. Obtuse angle θ1, θ2, θ3 is used as the driving angle of each of six driving sections 101 of driving tool 10. Each concave portion 106 is formed between two adjacent driving sections 101 and includes two side faces 103 and a bottom side 102 interconnected between side faces 103. Each side face 103 of each concave portion 106 is interconnected to one of first and second planar driving faces 104.

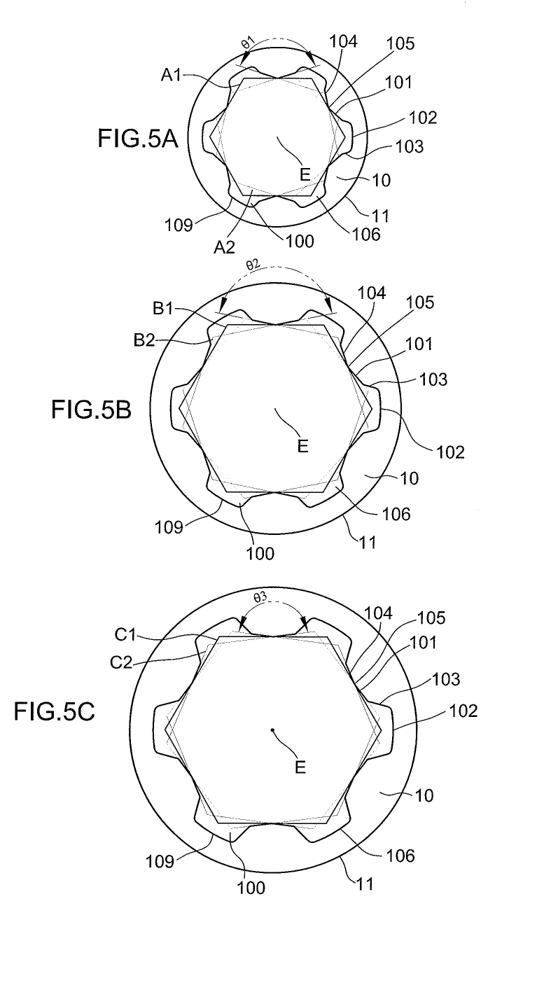

Referring to FIGS. 5A-5C, a circle 11 concentric with first hexagon A1, B1, C1 is drawn and surrounds circle R1, R2, R3. Circle 11 has a diameter greater than that of circle R1, R2, R3 and defines outer periphery 11 of driving tool 10. FIGS. 6A-6C show the final product of driving tools 10 whose driving angles θ1, θ2, θ3 are determined by the method according to the teachings of the present invention. Note that central axes O of driving tools of FIGS. 6A-6C respectively extend through centers E shown in FIGS. 5A-5C.

It can be appreciated that driving angles θ1, θ2, θ3 of driving tools 10 according to the teachings of the present invention differ from one another to suit fasteners of differing sizes while the driving tools 10 having the same number of driving faces 104 to reduce the costs for manufacturing driving tools 10. Furthermore, coupling of driving tools 10 according to the teachings of the present invention with fasteners of differing sizes can be easily achieved.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A driving tool kit comprising:
a first driving tool including a first opening adapted to selectively receive one of a first fastener with a first nominal size of imperial units for fasteners and a second fastener with a first nominal size of metric units for fasteners corresponding to the first nominal size of imperial units for fasteners, with each of the first and second fasteners including a plurality of sides, with the first opening including a first central axis and a first inner periphery surrounding the first central axis, with the first inner periphery including a plurality of first driving sections spaced from one another at regular intervals in a first circumferential direction surrounding the first central axis, with each of the plurality of first driving sections including first and second planar driving faces meeting at a first intersection and at a first obtuse driving angle (θ1) to each other, with the first intersections of the plurality of first driving sections being adapted to engage with the plurality of sides of a larger one of the first and second fasteners, with the first planar driving faces and the second planar driving faces of the plurality of first driving sections being adapted to selectively engage with the plurality of sides of a smaller one of the first and second fasteners;
a second driving tool including a second opening adapted to selectively receive one of a third fastener with a second nominal size of imperial units for fasteners and a fourth fastener with a second nominal size of metric units for fasteners corresponding to the second nominal size of imperial units for fasteners, with the second nominal size of imperial units for fasteners different from the first nominal size of imperial units for fasteners, with the second nominal size of metric units for fasteners different from the first nominal size of metric units for fasteners, with each of the third and fourth fasteners including a plurality of sides, with the second opening including a second central axis and a second inner periphery surrounding the second central axis, with the second inner periphery including a plurality of second driving sections spaced from one another at regular intervals in a second circumferential direction surrounding the second central axis, with each of the plurality of second driving sections including third and fourth planar driving faces meeting at a second intersection and at a second obtuse driving angle (θ2) to each other, with the second obtuse driving angle (θ2) different from the first obtuse driving angle (θ1), with the second intersections of the plurality of second driving sections being adapted to engage with the plurality of sides of a larger one of the third and fourth fasteners, with the third planar driving faces and the fourth planar driving faces of the plurality of second driving sections being adapted to selectively engage with the plurality of sides of a smaller one of the third and fourth fasteners; and
a third driving tool including a third opening adapted to selectively receive one of a fifth fastener with a third nominal size of imperial units for fasteners and a sixth fastener with a third nominal size of metric units for fasteners corresponding to the third nominal size of imperial units for fasteners, with the third nominal size of imperial units for fasteners different from the first and second nominal sizes of imperial units for fasteners, with the third nominal size of metric units for fasteners different from the first and second nominal sizes of metric units for fasteners, with each of the fifth and sixth fasteners including a plurality of sides, with the third opening including a third central axis and a third inner periphery surrounding the third central axis, with the third inner periphery including a plurality of third driving sections spaced from one another at regular intervals in a third circumferential direction surrounding the third central axis, with each of the plurality of third driving sections including fifth and sixth planar driving faces meeting at a third intersection and at a third obtuse driving angle (θ3) to each other, with the third obtuse driving angle (θ3) different from the first and second obtuse driving angles (θ1, θ2), with the third intersections of the plurality of third driving sections being adapted to selectively engage with the plurality of sides of a larger one of the fifth and sixth fasteners, with the fifth planar driving faces and the sixth planar driving faces of the plurality of third driving sections being adapted to selectively engage with the plurality of sides of a smaller one of the fifth and sixth fasteners.

2. The driving tool kit as claimed in claim 1, with the first inner periphery further including a first concave portion intermediate two of the plurality of first driving sections adjacent to each other, with each of the first concave portions including two first side faces and a first bottom side interconnected between the two first side faces, with each of the two first side faces of each of the first concave portions interconnected to one of the first and second planar driving faces, with the first bottom side having a first spacing to the first central axis in a radial direction perpendicular to the first circumferential direction larger than each of the first and second planar driving faces, with the second inner periphery further including a second concave portion intermediate two of the plurality of second driving sections adjacent to each other, with each of the second concave portions including two second side faces and a second bottom side interconnected between the two second side faces of the second concave portion, with each of the two second side faces of each of the second concave portions interconnected to one of the third and fourth planar driving faces, with the second bottom side having a second spacing to the second central axis in a radial direction perpendicular to the second circumferential direction larger than each of the third and fourth planar driving faces, with the third inner periphery further including a third concave portion intermediate two of the plurality of third driving sections adjacent to each other, with each of the third concave portions including two third side faces and a third bottom side interconnected between the two third side faces of the third concave portion, with each of the two third side faces of each of the third concave portions interconnected to one of the fifth and sixth planar driving faces, with the third bottom side having a third spacing to the third central axis in a radial direction perpendicular to the third circumferential direction larger than each of the fifth and sixth planar driving faces.

3. A method for determining a driving angle of an opening of a driving tool, with the opening adapted to selectively receive one of a first fastener with a nominal size of imperial units for fasteners and a second fastener with a nominal size of metric units for fasteners corresponding to the nominal size of imperial units for fasteners, with each of the first and second fasteners including six sides, with the opening including an inner periphery having six driving sections spaced from one another at regular intervals in a circumferential direction, with each of the driving sections including first and second planar driving faces at the driving angle to each other, with the method comprising:
drawing a first hexagon (A1) including six first sides corresponding to the six sides of a larger one of the first and second fasteners, with the first hexagon defining a center (E) surrounded by the six first sides, with a midpoint (a1) of one of the six first sides of the first hexagon (A1) being selected as a reference point;
drawing a second hexagon (A2) inside of and concentric with the first hexagon (A1), with the second hexagon (A2) including six second sides corresponding to the six sides of a smaller one of the first and second fasteners, with the six second sides of the second hexagon (A2) respectively parallel to and spaced from the six first sides of the first hexagon (A1), with one of the six second sides of the second hexagon (A2) being selected as a reference side (a2);
rotating the second hexagon (A2) about the center (E) in a clockwise direction to a first position with the reference side (a2) of the second hexagon (A2) intersecting the reference point (a1) of the first hexagon (A1), with the reference side (a2) of the second hexagon (A2) in the first position having a first segment extending from the reference point (a1) and outside of the first hexagon (A1);
rotating the second hexagon (A2) about the center (E) in a counterclockwise direction to a second position with the reference side (a2) of the second hexagon (A2) intersecting the reference point (a1) of the first hexagon (A1), with the reference side (a2) of the second hexagon (A2) in the second position having a second segment extending from the reference point (a1) and outside of the first hexagon (A1), with the first and second segments outside of the first hexagon (A1) meeting at the reference point (a1) and defining an obtuse angle (θ1, θ2, θ3); and
using the obtuse angle (θ1, θ2, θ3) as the driving angle of each of the six driving sections of the driving tool.

4. The method as claimed in claim 3, further comprising: selecting a portion of the first segment as a length (W1, W2, W3) of the first planar driving face, and selecting a portion of the second segment as a length (W1, W2, W3) of the second planar driving face.
